(19) United States
(12) Patent Application Publication
(10) Pub. No.: US 2003/0047879 A1
(43) Pub. Date: Mar. 13, 2003

(54) Rotary sealing device

(76) Inventor: Willard L. Bowen, Harwinton, CT (US)

Correspondence Address: Willard L. Bowen, 11 Village Lane, Harwinton, CT, 06791, US

(21) Appl. No.: 10/122,357

(22) Filed: Apr. 15, 2002

Related U.S. Application Data
(60) Provisional application No. 60/318,610, filed on Sep. 10, 2001.

(51) Int. Cl. F16J 15/16

(52) U.S. Cl. 277/500

(57) ABSTRACT

A rotary sealing device to prevent the intrusion of coolant, grit and other unwanted material into operational bearings. Said device consists of a annular rigid body made of composite, plastic or metal material that is sealed to the rotating shaft with rubber-like o-rings. One or more flexible rings (similar to piston rings) are fitted into grooves on the outer periphery of the annular rigid body. The flexible rings compress to fit tightly in the housing or end cap of the unit containing the bearing to be sealed. Grease or similar liquid material in the grooves of the circular rigid body seal to the flexible rings, yet allow free rotation between the rings and the rigid body. Low friction allows high rotational speeds with little heat generation by the seal itself.

### CROSS-REFERENCE TO RELATED APPLICATIONS

| | | | |
|---|---|---|---|
| 5,678,828 | 10/1997 | Hamaya | Sealing device |
| 5,636,848 | 6/1997 | Hager et al | Oil seal for high speed rotating |
| | | | shaft. |
| 5,632,494 | 5/1997 | Oka | Seal ring & seal device |
| 5,441,282 | 8/1995 | Ciotola | Mechanical seal |
| 5,431,414 | 7/1995 | Fedorovich et al | Seal device |
| 5,378,000 | 1/1995 | Orlowski | Shaft seal assembly |

### FEDERALLY SPONSERED RESEARCH OR DEVELOPMENT

Not Applicable

### COMPUTER PROGRAM LISTING

Not Applicable

### BACKGROUND OF THE INVENTION

This invention relates to the sealing of bearings, such as ball bearings or roller bearings, to prevent the intrusion of dirt or moisture into the bearing, thus increasing their useful life.

It is well known that contamination of ball and roller bearings is responsible for most early bearing failures. Less than 30% of all ball and roller bearings realize their full rated life because of contamination of the bearing lubricant.

Small amounts of moisture entering a bearing will emulsify the grease causing lubricant breakdown and early bearing failure. Grit in a bearing causes rapid abrasive wear.

Most bearing seals fall into three categories; lip seals, face seals and labyrinth seals. Lip seals rub the rotating shaft and tend to cause heat and wearing of the shaft. Face seals usually bear against the end face of the bearing or shaft and develop unwanted heat at higher speeds. Labyrinth seals are designed to work only when rotation takes place and can leak at zero speed.

Lip seals are usually mounted in the housing next to the bearing with the lip rubbing the rotating shaft. Grit accumulates at the lip causing abrasive wear on the shaft and subsequent leaking past the seal into the bearing.

Face seals are spring-loaded and usually bear against a rotating member. The resulting friction causes high heat, which is harmful to precision bearing applications. Also, face seals require considerable axial space, which is a problem in most spindle designs because the bearing needs to be close to the working end for maximum shaft stiffness.

Labyrinth seals are made with interlocking parts designed to throw off grit and water, but when stationary can allow moisture to be sucked through the seal into the bearing area. Labyrinth seals usually require considerable axial space.

### SUMMARY OF THE INVENTION

The object of this invention is to eliminate some of the drawbacks encountered in the prior art described above and to provide a sealing device that is easily applied to a wide variety of bearing applications.

This and other objects of the present invention can be achieved by providing a sealing device comprising an annular first seal member composed of a rigid composite material, with one or more rubber o-rings in the annular bore of first seal member and a second seal member composed of sliding metal rings in grooves on the outer annular surface of first seal member.

In the preferred embodiment, rubber o-rings seal the body tightly to the rotating shaft to prevent any grit or contamination from entering into the bearing and by friction of the rubber o-rings, the annular first seal member is caused to rotate with the shaft. Further, the second seal members are compressed to seal tightly to the bearing housing. Sealing between the first and second seal members is achieved with grease or other sealing fluid carried in the annular grooves of the first seal member.

A second object of this invention is to seal in the lubricant in the bearing and prevent if from being worked out of the bearing by centrifugal force. Lubricant such as oil or grease is essential to all ball and roller bearings because of the thin film it forms between the rolling elements and the raceway surfaces to prevent metal-to-metal contact. Without proper lubrication bearings fail rapidly because high contact pressures between rolling elements and races cause rapid surface wear and spalling.

Another object of this invention is to allow easy mounting in most spindle bearing units without the use of special tools. Also, the symmetrical design of this invention allows mounting with either seal face forward.

### BRIEF DESCRIPTION OF THE DRAWINGS

FIG. 1A perspective view of the seal showing its three components.

FIG. 2A cross-section and side view showing multiple flexible outer rings.

FIG. 3A cross-section and side view of the seal with a single ring, illustrating its narrow design.

FIG. 4A cross-section and side view of an inverted seal design.

FIG. 5A cross-sectional view of the seal assembled into a machine spindle.

### DESCRIPTION OF PREFERRED EMBODIMENT

The present invention will be described below with reference to the accompanying drawings.

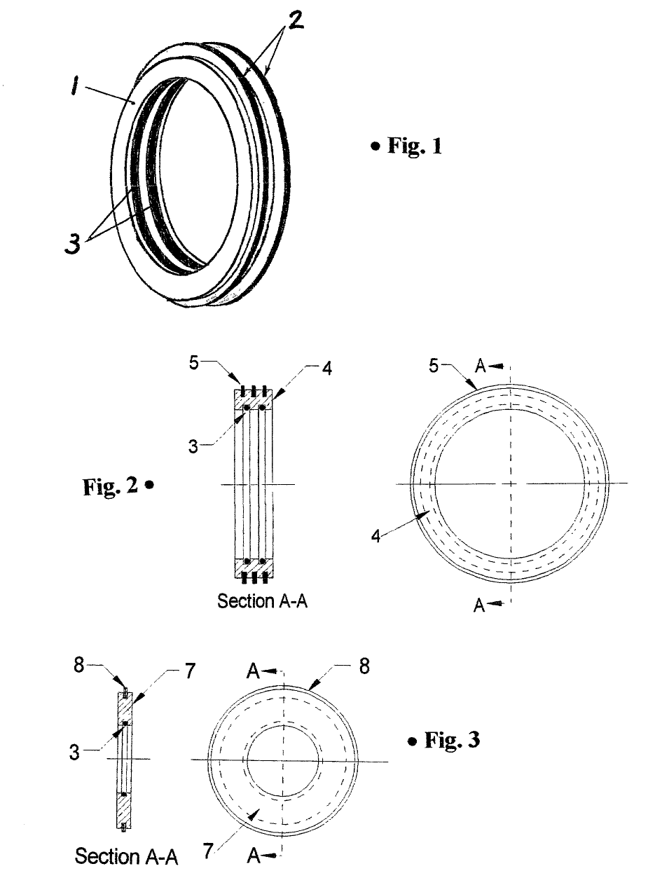

FIG. 1 is a perspective view showing the basic design of this rotary seal device as composed of three parts. The body 1 of the seal is a rigid annular member with parallel annular grooves on the outer peripheral surface and the inner surface. Flexible metal rings 2 are rotatably mounted in said outer annular grooves, and rubber o-rings 3 are fitted in said inner grooves of seal body 1.

FIG. 2 shows side and cross-sectional views of this invention with three flexible circular metal outer rings 5 rotatably mounted on the periphery of annular body 4. Two o-rings 3 are shown fitted to recessed grooves in the bore of body 4.

FIG. 3 shows the side and cross-sectional views of this sealing device for use where space is limited and a narrow seal is required. A single flexible outer ring 8 is rotatably mounted on annular body 7 and a single o-ring 3 is fitted into the bore of body 7.

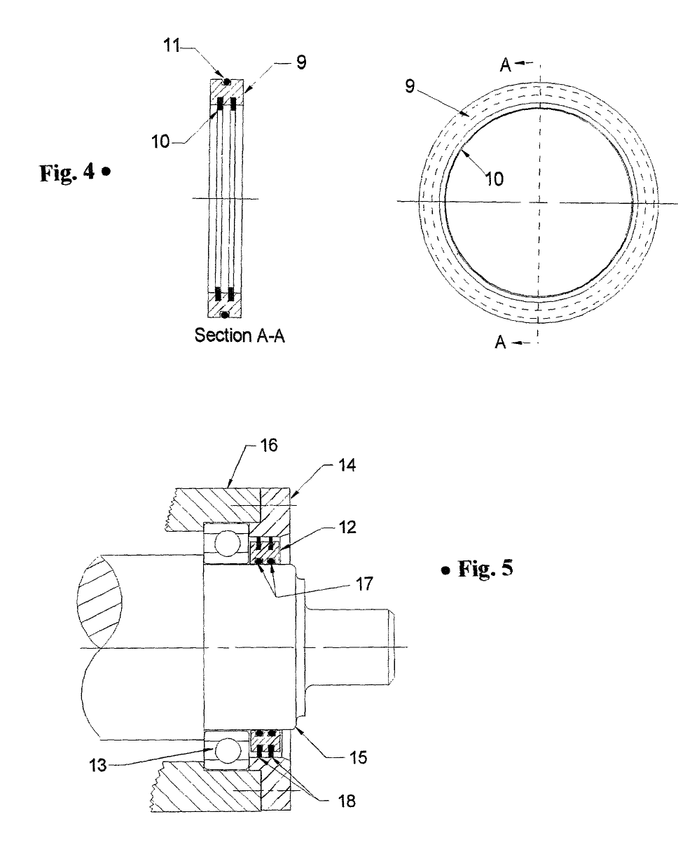

FIG. 4 shows the side and cross-sectional views of a rotary seal of inverted design. Rubber o-ring 11 is located on the outer diameter of annular body 9 to provide a static seal. Flexible circular rings 10 are rotatably mounted in grooves in the bore of annular body 9.

FIG. 5 shows the seal invention 12 suitably positioned in a machine spindle assembly 16 next to bearing 13. Seal 12 is held to shaft 15 by the friction of compressed o-rings 17 and so as to rotate with shaft 15. Flexible circular rings 18 are compressed to seal tightly to the bore of spindle end cap 14.

What I claim as my invention is:

1. A rotary sealing device for the protection of bearings comprising;
an annular first seal member comprised of a rigid composite material, having a rectangular cross-section and with annular grooves on both the inner and outer peripheral surfaces,
wherein a second seal member comprised of one or more spring steel rings rotatably mounted in the outer grooves of said first seal member and able to be radially compressed so as to fit tightly in the inner peripheral bore of a bearing housing,
and a third seal member consisting of one or more rubber o-rings in the inner peripheral surface of said first seal member to frictionally engage and seal said first seal member to a rotating shaft, so as to completely seal the space between a rotating spindle shaft and a stationary housing containing the bearing to be sealed.

2. The sealing device according to claim 1, wherein said first seal member is comprised of a plastic or of metal or of composite material.

3. The sealing device according to claim 1, wherein said second seal member is comprised of plastic or metal or composite material.

4. The sealing device according to claim 1, wherein said second circular seal member is comprised of a double-turn ring having a fully circular outer periphery with no gaps.

5. The sealing device according to claim 1, wherein said third seal member is a compressible material to both seal and bind said first seal member to a rotating shaft.

6. A rotary sealing device comprising;
an annular first seal member comprised of rigid composite material, having a rectangular cross-section and annular grooves on both inner and outer peripheral surfaces,
wherein a second seal member comprised of flexible steel rings mounted in grooves in the bore of the first seal member,
and a third seal member consisting of one or more rubber o-rings mounted on the outer periphery of the first seal member.
